(19) United States
(12) Patent Application Publication
(10) Pub. No.: US 2005/0119956 A1
(43) Pub. Date: Jun. 2, 2005

(54) Methods and software applications for computer-aided customer independent cash collection using a state field in a data record

(76) Inventor: Mike Soumokil, Vught (NL)

Correspondence Address: FINNEGAN, HENDERSON, FARABOW,;GARRETT & DUNNER, L.L.P., 1300 I Street, N.W., Washington, DC, 20005, US

(21) Appl. No.: 10/972,678

(22) Filed: Oct. 26, 2004

Related U.S. Application Data
(60) Provisional application No. 60/515,660, filed on Oct. 31, 2003.

(51) Int. Cl. G06F 17/60; B07C 5/00; G06K 9/00

(52) U.S. Cl. 705/34

(57) ABSTRACT

Methods and systems are disclosed for the computerized processing of invoices. In one exemplary embodiment, a method is provided that comprises selecting, from a plurality of invoices, invoices that are due within a preselectable time or on a preselectable date and having a balance that is larger than a preselectable first value, and assigning a first state to the selected invoices.

### CROSS-REFERENCE TO RELATED APPLICATION(S)

The present application claims the benefit of priority to U.S. Provisional Application No. 60/515,660, filed on Oct. 31, 2003, the disclosure of which is expressed incorporated herein by reference to its entirety.

### FIELD OF THE INVENTION

The present invention generally relates to the area of electronic data processing. More particularly, the invention relates to methods, data structures, computer program products and systems for automated processing of invoices.

### BACKGROUND INFORMATION

The processing of invoices using electronic data records of the invoices is known in the art. Such data records are used in enterprise business software to store financial data related to items or activities, such as the sale of a product. These data records may also be used for providing financial data for credit and risk management purposes.

Although the data records are typically stored in the computer system of the respective company (or enterprise), it is not in any case certain whether the invoice has been actually paid, or whether a dispute has been opened on the invoice, the whole sale, the order process, and/or contract issues. Other problems can also exist that may prevent or delay or prevent payment of an invoice. Consequently, if the management of an enterprise analyzes the financial situation on the basis of uncertain invoice data, the result may be misleading or show a financial situation of the enterprise which is different from the real financial situation. Further, the company may not be aware of the need to collect the cash from active debts, and even if the company is aware, it is not in any case clear on which part of the outstanding invoices the efforts of cash collecting should be focused. This is particularly a problem if a large number of invoices have been sent to a plurality of customers.

Thus, there is a need for methods, software applications and/or data processing systems to provide a more efficient solution to at least a part of the problems described above. Moreover, it is desirable to provide a software application having a mechanism for enabling better processing of invoices and/or for facilitating collection according to the company's active debts from customers.

The above description is based on the knowledge of the present inventors and not necessarily that known in the art.

### SUMMARY OF THE INVENTION

According to the present invention, as embodied and broadly described herein, methods and systems consistent with the principles in this disclosure may provide for computerized processing of invoices. The invoices may be presented by a customer to two or more customers.

In accordance with one embodiment, a data processing system is provided comprising means for receiving a dataset, means for assigning a first control code to the dataset, if the dataset fulfills a predefined condition, database means for storing the dataset and its assigned first control code, means for retrieving datasets having an assigned first control code from the database, and means for processing the retrieved datasets.

One advantage of the invention is that it may reduce the amount of data processing that is required for processing a given number of datasets. Assigning the first control code to a dataset that fulfills a predefined condition may be advantageous because processing can be limited to the sub-set of the datasets that have the assigned first control code. This may avoid the need to process all datasets by limiting the number of datasets to those that meet a special condition and which have thus a higher priority over other datasets that have not assigned the first control code.

In accordance with another embodiment, the second control code may be assigned to those datasets that have an assigned first control code. The second control code may be used for the subsequent processing of the retrieved datasets. For example, the second control code may determine a type of an electronic message that is to be sent for a given dataset and/or whether an additional item for an operator's to-do-list is to be generated for the respective dataset.

Another advantage of the invention may be for the computerized processing of invoices. The invoices may be presented by a customer to two or more customers.

In accordance with yet another embodiment of the invention, a method is provided that comprises: selecting, from a plurality of invoices, invoices that are due within a preselectable time or on a preselectable date and having a balance that is larger than a preselectable first value, and assigning a first state to the selected invoices.

According to another embodiment, a method is provided for computerized processing of invoices, wherein the invoices are presented by a company to two or more customers. The method may comprise selecting, from a plurality of invoices, one or more invoices that are due within a preselectable time or on a preselectable date and to which a first state is assigned, and assigning a second state to the selected invoices.

In accordance with yet another embodiment, a computer system is provided for computerized processing of invoices. The computer system may comprise a memory with program instructions, input means for receiving and entering data, output means for sending and presenting data, storage means for storing data, and a processor responsive to the program instructions. The instructions may be adapted to cause the processor to select from a plurality of invoices such invoices that are due within a preselectable time or on a preselectable date and that have a balance that is larger than a preselectable first value, and assign a first state to the selected invoices.

In yet another embodiment, a computer system is provided for computerized processing of invoices. The computer system may comprise a memory with program instructions, input means for receiving and entering data, output means for sending and presenting data, storage means for storing data, and a processor responsive to the program instructions. The instructions may be adapted to cause the processor to select from a plurality of invoices such invoices that are due within a preselectable time or on a preselectable date and to which a first state is assigned, and assign a second state to the selected invoices.

One advantage of this computer system is that the collection of outstanding cash independent of a specific customer is made easier. A company can focus its capacity of cash collection on such invoices, which are considered to be most important with respect to its turnover. Embodiments of the invention may further allow a company to have an overview of critical invoices before the respective due dates, so that measures to ensure punctual payment can be taken in good time. Further, the management of the respective company can get an improved day sales outstanding, better management of liquidity, improved credit risk management through more transparency, better customer profiling through company owned credit scores, better accounts receivable reporting, and/or better communication with customers.

Embodiments of the invention are further directed to computer systems, computer programs, computer readable media and carrier signals, each comprising program code or instructions for computerized processing of invoices. Such embodiments may be implemented consistent with the above-described methods or systems.

Computer programs can be installed as one or more programs or program modules on different hardware systems (computers or computer systems), run separately and independently of each other, and in their entirety be capable of performing methods consistent with embodiments of the invention. The different systems may be connected directly or in the form of a network to communicate with each other.

Additional objects and advantages of the invention will be set forth in part in the description, or may be learned by practice of the embodiments of the invention disclosed herein. The various embodiments can include and/or exclude different aspects, features and/or advantages, where applicable. In addition, various embodiments can combine one or more aspects or features of other embodiments, where applicable.

It is understood that both the foregoing general description and the following detailed description are exemplary and explanatory only and are not restrictive of the embodiments of the invention, as claimed. Further, the description of aspects, features and/or advantages of particular embodiments should not be construed as limiting other embodiments or the claims.

### BRIEF DESCRIPTION OF THE DRAWINGS

The accompanying drawings, which are incorporated in and constitute a part of this disclosure, illustrate by way of examples various embodiments and aspects of the invention. In the drawings:

FIG. 1 is a block diagram of an exemplary computer system, consistent with an embodiment of the invention;

FIG. 2 is a flow diagram of an exemplary method for processing invoices, consistent with an embodiment of the invention;

FIG. 3 is a flow diagram of another exemplary method for processing invoices, consistent with an embodiment of he invention;

FIG. 4 is a flow diagram of yet another exemplary method for processing invoices, consistent with an embodiment of the invention;

FIG. 5 is a flow diagram of still another exemplary method for processing invoices, consistent with an embodiment of the invention;

FIG. 6 is a flow diagram of another exemplary method for processing invoices, consistent with an embodiment of the invention;

FIG. 7 is a block diagram of an exemplary data structure for processing invoices, consistent with an embodiment of the invention;

FIG. 8 is a block diagram of an exemplary data processing system, consistent with an embodiment of the invention;

FIG. 9 is a flow diagram illustrating an exemplary assignment of control codes to the dataset, consistent with an embodiment of the invention; and

FIG. 10 is a flow diagram illustrating an exemplary processing of datasets that have assigned control codes, consistent with an embodiment of the invention.

### DESCRIPTION OF THE EMBODIMENTS

Reference will now be made in detail to the present exemplary embodiments of the invention by reference to the accompanying drawings. Wherever possible, the same reference numbers will be used throughout the drawings to refer to the same or like parts.

Within the concept of this disclosure, the terms used shall have their usual meaning in the context of the field of data processing, unless defined otherwise herein.

A computer system broadly refers to any stand alone computer, such as a personal computer (PC) or a laptop or a series of computers connected via a network, e.g., a network within a company, or a series of computers connected via the Internet.

Computer systems and programs may be closely related. As used herein, phrases, such as “the computer provides,” “the program provides or performs specific actions,” and “a user performs a specific action” are used to express actions by a computer system that may be controlled by a program to express that the program or program module may be designed to enable the computer system to perform the specific action or to enable a user to perform the specific action by means of a computer system.

It should be understood that the term “presentment” as used herein broadly refers to the specialized definition normally associated with commercial paper (i.e., the production on a negotiable instrument to a drawee), as well as to providing information via electronic means. For example, an electronic presentment may be through the use of the Internet, an intranet website, via e-mail or SMS, e.g., by making a web site accessible to one or more persons. Electronic presentment may also take place by sending computer readable storage media, like disks, ZIP disks, magneto-optical disks, CDs, R/W discs, DVD ROMs etc., e.g. via standard mail.

Reference will now be made in detail to exemplary embodiments and features of the invention by an explanation on the basis of a data processing process, examples of which are illustrated in the accompanying drawings.

In electronic data processing, particularly in accounting processes, the content of invoices may be stored in electronic data records. Such data records may be implemented as one or more lines of one or more tables, each line having one or more fields. In object orientated programming an electronic data record may be implemented by an instance of a class. The class may include a plurality of variables. The class may also include a one or more functions that are operable on the instances (invoices). The fields or variables contain typical invoice information, such as the name of a customer, addresses, product, price, account number, payment terms, tax, contact person, invoice date, due date, person responsible for changes in the document on the customer side, or responsible person for authorization.

In one embodiment, a set of electronic data records may be queried to extract such records which meet the condition according to which the respective invoices are due within a preselectable time or on a preselectable date, and the balance of which invoices is larger than a preselectable first value. Subsequently, a first state is assigned to the thus selected invoices.

An example of an implementation of assigning a state to the invoices is that the electronic data record may comprise a data field comprising the state of the invoice. This field is hereinafter referred to as a “state field.” The state field may be implemented as a string field, with a length of 1, 2, 3, 4, 5, 6, 7, 8 or more characters, depending on the number of possible states that shall be available. By way of non-limiting examples, the following states may be characterized: paid, unpaid, balance>first value, due, undue, for cash collection, special attention, high priority, medium priority, low priority, problem indicators on contract issues, invoice content, lay-out issues, issues to be handled by responsible managers, escalated matters, internal status, number of days outstanding, and/or payment date of document. As will be appreciated, these states are examples and not intended to limit the scope of the invention.

In one embodiment, the selected invoices may be stored as a separate set or marked as selected.

In yet another embodiment of the invention, it may be determined, e.g., by the computer system, whether payments have been received for the selected invoices. Invoices for which no payments or only partial payments have been received may be further extracted, e.g., by storing them separately or marking. Both steps may also be performed in an inverted order or as a single query. Invoices having a certain state, e.g., “for cash collection” may be automatically presented to a collecting service. A collecting service may be, for example, a case worker of the company, and the presentation to him/her may be performed as pointed out above, e.g., by sending an e-mail which may include a file with the selected set of invoices, a link pointing to the storage location of such a file, or a link to a web page, which contains the selected invoices and which may comprise further information like correspondence, notes, scanned letters, etc. The caseworker then can decide what further actions are to the performed. The caseworker may, for example, send an e-mail to the customer or call the customer directly via telephone or the like. After presenting the selected invoices to the collecting service, the states of the invoices may be changed accordingly. It should be noted that the selection is not based on invoices for a specific customer, but it is made customer independent over a plurality of invoices. This allows independent reporting, which can result in a better overview over the financial situation of the company. As an example, invoices of high priority may be presented 10 days before their due date, medium priority 7 days before their due date, and low priority invoices on the due date. The mentioned values are examples and depend on the needs or intention of the respective company. Instead of priority, the amount of the balance may be used as well.

In accordance with another embodiment, a method is provided that comprises selecting, from a plurality of invoices, one or more invoices and assigning a second state to the selected invoices. The assignment of the second state may be implemented by a second data field in a data record analogous to that pointed out above. Alternatively, the assignment of two (or more) states may also be implemented by defining a first number of characters of the string in the state field as representing the first state and a second number of characters subsequent to the first number as representing a second state and so forth. For example, if a string in the state field consists of 8 characters “ABCDEFGH”, the first two characters (AB) may define the first state, the following 3 characters (CDE) may define a second state, the following two characters (FG) may define a third state, and the last character (H) may define a fourth state. Of course, any such combination may be applied, and any meaning can be assigned to any state. This is on the discretion of the user of the method and computer system.

An alternative method for computerized processing of invoices may comprise selecting, from a plurality of invoices, such invoices that are due within a preselectable time or on a preselectable date and to which a first state is assigned, one or more invoices and assigning a second state to the selected invoices. Such a method may be accomplished by, e.g., applying the principles pointed out above.

A further embodiment of the present invention relates to a method for processing invoices, wherein one or more invoices are invoices of special importance. Cases of special importance may be, for example, cases in which non-standard business conditions have been agreed upon in the underlying contract, e.g., special payment conditions, special discount, and conditions deviating from the standard business conditions of the company, etc.

A further embodiment comprises selecting, from a plurality of invoices, such invoices having a balance that is larger than a preselectable first value.

Another embodiment consistent with the present invention comprises assigning first and second states of high priority.

A still further embodiment comprises selecting, from a plurality of invoices, such invoices having a balance of which is smaller than a preselectable second value and larger than a preselectable third value, and assigning a third state to such selected invoices, the second value being smaller or equal than the first value, and the third value being smaller than the second value.

In a further embodiment, the method may comprise assigning a second state, wherein the second state is a state of medium priority.

A further embodiment comprises selecting, from the plurality of invoices, one or more invoices with a balance that is smaller than a third value, and assigning a fourth state to such selected invoices.

A further embodiment of methods consistent with the present invention comprises a fourth state that is a state of low priority.

In still a further embodiment, the preselectable first value is such that a preselectable percentage of the outstanding active debts or turnover of the company is controlled.

A further embodiment consistent with the present invention comprises presenting the invoices of the first and/or second and/or third and/or fourth state to a cash collector.

A still further embodiment consistent with the present invention comprises presenting the invoices with a first or second state at the latest at a presetable first period of time before the due date to the cash collector.

A still further embodiment comprises presenting the invoices with a third state at the latest at a presetable second period of time before the due date to the cash collector.

A still further embodiment consistent with the present invention comprises presenting the invoices with the fourth state at the latest at a presetable third period of time before the due date to the cash collector.

A still further embodiment consistent with the invention comprises controlling, by the case collector, whether payments according to the invoices of the first and/or second state have been made before or on or after the due date and, in case of a non payment, presenting such invoices to a collecting service.

A still further embodiment consistent with the present invention comprises a second period of time that is smaller than a first period of time and a third period of time is smaller than the second period of time.

A still further embodiment consistent with the present invention comprises dunning the customers of the accompanying due invoices.

In a still further embodiment consistent with the present invention a collection service is provided that is a collection division of the company or an external collecting agency.

A still further embodiment consistent with the present invention comprises checking whether a non-payment is reasoned and, in the case it is not, presenting such invoice to an external collecting agency.

A still further embodiment consistent with the present invention comprises presenting the selected invoices to the collecting service by means of, for example, a to-do-list.

A still further embodiment consistent with the present invention comprises receiving a request for a state change of an invoice from a customer and changing the state of the invoice according to the request.

A still further embodiment consistent with the present invention comprises presenting the request to an internal clearing division before changing the state.

A still further embodiment consistent with the present invention comprises selecting from the selected invoices such invoices, the due date of which has expired, controlling whether a payment regarding the respective invoice has been received before or on the time of selection, and presenting the selected invoices to a collecting service.

A further embodiment consistent with the present invention comprises instead of or in addition to selecting from the selected invoices such invoices, the due date of which has expired, the method comprising selecting from the plurality of invoices such invoices, the balance of which is smaller than a preselectable second value, and larger than a preselectable third value, the second value being smaller or equal than the first value and the third value being smaller than the second value, before continuing with the step of controlling whether a payment regarding the respective invoice has been received before or on the time of selection.

A further embodiment consistent with the present invention comprises in the step of selecting from the plurality of invoices such invoices, the balance of which is smaller than a preselectable second value, and larger than a preselectable third value, the second value being smaller or equal than the first value and the third value being smaller than the second value, selecting from the selected invoices such invoices, which are due within a preselectable time or on a preselectable date. This can be useful because it enables a company to efficiently check whether its invoices are paid in due time. For example, a collecting service (case worker) receives a list of invoices, which are due in two days. The case worker can now schedule his/her time, because he/she knows how many and what invoices he/she has to check on payment in two days.

A further embodiment consistent with the present invention comprises instead of or in addition to presenting the selected invoices to a collecting service, the method comprising dunning the customers of the accompanying unselected due invoices. With this method, minor important invoices can be automatically processed, e.g., by automatically sending personalized circular letters or mails.

A further embodiment consistent with the invention comprises when presenting the selected invoices to a collecting service, also presenting the selected invoices via a to-do-list.

The presentation of a to-do-list may be accomplished by presenting the selected invoices in the form of a list on a display of the computer system of a caseworker. This can be done automatically or by sending a link to the file that contains the list. Further, the list may be provided with check-boxes, alerts, or proposals for actions, each depending on the state of the respective invoice.

In a further embodiment, a preselectable first value is provided where a preselectable first percentage of the outstanding active debts or turnover of the company is covered. The first percentage may range, for example, from 90 to 70%, depending on the intention of the company. For example, 80% may be a useful value in a variety of cases. The actual number of the first value can, for example, be determined iteratively by successively increasing the first value from a start value (e.g., zero is the trivial case) and checking within each step, which percentage of the turnover is covered, and taking that number as the first value, the accompanying percentage of which equals the desired value of turnover.

A further embodiment consistent with the present invention may comprise preselectable first, second and third values wherein these values are such that a preselectable second percentage of the outstanding active debts or turnover of the company is covered. The second percentage may, for example, range from 70 or 80% or 90 to 100%, including all interim values, depending on the intention or needs of the company. The selection according to this embodiment is insofar advantageous as it helps ensuring that unselected invoices represent only a comparatively small percentage (100—second percentage) of the company's turnover.

Another embodiment consistent with the present invention comprises when presenting the selected invoices to a collecting service, also checking whether a partial-or non-payment is reasoned, and in the case it is not, presenting such unreasoned partial or non-paid invoices to a collecting agency. Within the concept of this disclosure, the term “collecting agency” broadly refers to collection divisions of the company, as well as to collecting agencies different from the company. After presenting the invoices to the collecting agency, the states of the respective invoices may be changed accordingly.

A further embodiment consistent with the present invention comprises when presenting the selected invoices to a collecting service, also presenting not due invoices at the latest at a presetable first period of time before the due date to the collecting service.

A further embodiment consistent with the present invention comprises when selecting from the plurality of invoices such invoices, the balance of which is smaller than a preselectable second value, and larger than a preselectable third value, the second value being smaller or equal than the first value and the third value being smaller than the second value, also presenting not due invoices at the latest at a presetable second period of time before the due date to the collecting service.

A still further embodiment consistent with the present invention comprises instead of or in addition to selecting from the selected invoices such invoices, the due date of which has expired, and/or selecting from the plurality of invoices such invoices, the balance of which is smaller than a preselectable second value, and larger than a preselectable third value, the second value being smaller or equal than the first value and the third value being smaller than the second value, also selecting from the plurality of invoices such invoices, the balance of which is smaller than the third value.

A still further embodiment consistent with the present invention comprises in selecting from the plurality of invoices such invoices, the balance of which is smaller than a preselectable second value, and larger than a preselectable third value, the second value being smaller or equal than the first value and the third value being smaller than the second value, also presenting the invoices at the latest at a presetable third period of time before the due date to the collecting service.

A still further embodiment consistent with the present invention comprises the collecting service controlling whether payments according to the invoices have been made before or on or after the due date and, in case of a partial or non payment, presenting such invoices to a collecting agency.

A still further embodiment comprises checking whether a partial or non-payment is reasoned and, in case it is not, presenting such invoice to an external collecting agency.

A still further embodiment consistent with the present invention comprises presenting the invoices to a clearing division prior to presenting them to the external collecting agency. This can be useful because it enables the company to negotiate new payment conditions with the customers before escalating the case to the collecting agency. In case new payment conditions have been agreed upon, the step of presenting to the collecting agency can be omitted.

The preselectable first, second, and third values, times, dates and percentages can be stored in variables or tables and can be made editable through a user, e.g., a case worker of a collecting service.

A still further embodiment consistent with the present invention comprises a second period of time that is smaller than a first period of time, and a third period of time that is smaller than the second period of time. In a still further embodiment, the collection agency may be a collection division of the company or an external collecting agency.

A first embodiment of the electronic data record consistent with the present invention comprises of a state field that contains one or more sets of characters for the characterization of one or more states. An alternative embodiment consistent with the present invention comprises a data record that comprises one or more state fields for the one or more states. The above-mentioned states may be entered into the state field(s) by entering a characteristic character or combination of a few characters into the field(s), e.g., S1 to Sn for a number of n states. To each condition mentioned above, a state can be assigned and entered into the state field. Likewise, a state can be assigned to combinations of two or more conditions.

A further embodiment of the electronic data record consistent with the present invention comprises of state fields that are linked to one or more tables, which contains a description of a state. For example, the following descriptions can be entered in that table: balance>=X, X>balance>=Y, high priority, special case, high priority AND balance>=X, due within U days, due on “date”, etc.

A further embodiment of the electronic data record consistent with the present invention comprises of a state field that is directly or indirectly linked to a table, which contains one or more instructions, which depend on the state, and which are automatically executable by a computer system. For example, automatically dunning customers.

A further embodiment of the electronic data record consistent with the present invention comprises of a state field that is directly or indirectly linked to a table, which contains assignment of a state to an event, which might occur during the processing of the invoice. The following events may be typically contained: invoice blocked for payment either because of invoice lay-out not being complete, incomplete invoice reference, and/or quality or quantity issues on outstanding documents to be solved by responsible person within company. These events are examples and are not intended to limit the scope of this invention.

In a further embodiment, by means of a table, one or more proposals for a change of the state may be assigned to a state.

In still a further embodiment consistent with the present invention, the electronic data record comprises of a field for comments. This field may be implemented, for example, as a string field of a length of up to 128 characters or more.

A further embodiment consistent with the present invention comprises an electronic data record that is at least partially accessible via the Internet and wherein the content of the state field or a data field for comments is editable via the Internet. In order to achieve this, the respective data fields should be de-blocked for read/write access in the computer system in which the electronic data record is processed. Other selected fields of the electronic data record, the content of which fields may be of interest for a potential internet user, may be de-blocked for read access only.

A further embodiment consistent with the present invention comprises a state field that is linked to a table, which contains one or more state dependent proposals for changing the state. For example, if the state is that an invoice has to be paid in a few days, a proposed state after the due date is that the state may be changed in “not paid.” Alternatively, if certain situation has been clarified by a phone call, the sate it may have the state “will be paid with delay.”

A further embodiment consistent with the invention may comprise assigning a state, which may be entered by a user, to a state field. This may be implemented by an independent program, which may collect all changes of states in a predefinable time interval and which may write the changes periodically into the respective state fields.

A further embodiment consistent with the present invention may comprise selecting, sorting, evaluating, or analyzing the electronic invoices according to the state.

By using the above-described methods and generally known database query tools, a user—e.g., a collecting service—may get lists of all invoices that fulfill predefinable conditions with respect to the state field as pointed out above.

A further embodiment consistent with the present invention comprises calling a state dependent workflow. By using this approach, a workflow, which is designed to solve a specific problem, may be automatically initiated. For example, a dispute process can be initiated if a due invoice is not paid without a reasoned statement. Then mail may be automatically sent to a collecting agency in order to solve the problem. Further, a deadline can be issued on an outstanding problem. After an experiment date, the system may automatically send a reminder to the responsible persons to take action.

Further, the to-do-list can be initiated for cash collectors on outstanding items by sending, for example, a mail to responsible contact persons for the customers.

A still further embodiment consistent with the present invention comprises using the disclosed methods, data structures, and/or computer systems in, for or with an enterprise resource planning software.

An enterprise resource planning software herein broadly refers to any software or software package for supporting business processes of enterprises, including but not limited to accounting, administration, management, or production processes.

Processors suitable for the execution of a computer program for performing the methods and features disclosed herein include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, embodiments of the invention can be implemented on a computer system having a display device such as a CRT (cathode ray tube) or LCD (liquid crystal display) monitor for displaying information to the user and a keyboard and a pointing device such as a mouse or a trackball by which the user can provide input to the computer. Other kinds of devices can also be used to provide for interaction with a user as well. For example, feedback provided to the user can be any form of sensory feedback, such as visual feedback, auditory feedback, or haptic feedback. Also, input from the user can be received in any form, including acoustic, speech, or haptic input.

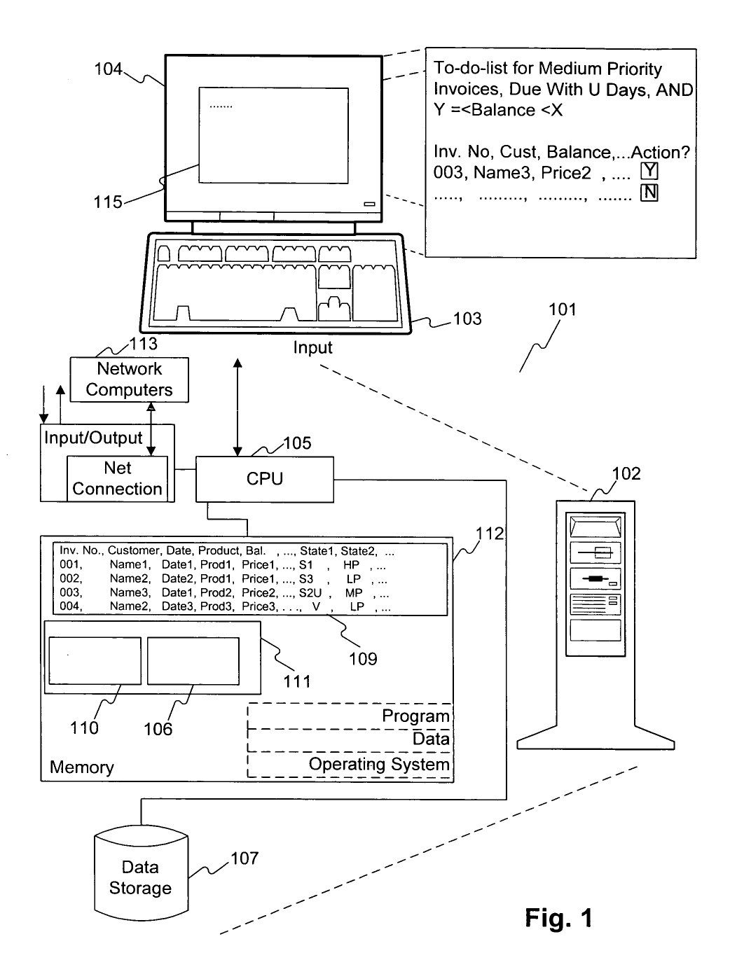

Referring to FIG. 1, an exemplary computer system is provided, consistent with an embodiment of the invention. In the example of FIG. 1, a computer system 101 is provided with program modules for processing electronic data records and performing method(s) consistent with the present invention. As shown, computer system 101 may comprise a computer 102 including a CPU 105, a memory 112 for storing an operating system, data and programs. In memory 112, a software application 111 is stored which may be processed by CPU 105. By way of example, software application 111 may comprise program modules 106, 110 for processing electronic data records according to the inventive method(s).

In one embodiment, the electronic data records are implemented in a table 109 comprising columns for typical invoice data and two columns, “State1” and “State2” for two types of states of the invoice. State1 may represent a general type, and State2 may represent a priority type. Table 109 is stored in computer memory 112 and on a non-volatile data storage device 107.

As shown in FIG. 1, computer system 101 may further comprise input means 103 and output means 104 for interaction with a user (e.g., for starting the program modules and/or for data input). General input/output means 108 may also be provided, including a net connection 114 for sending and receiving data. A plurality of computer systems 101 can be connected via the net connection 114 in the form of network computers 113. In this case, the network computers 113 can be used as further input/output means, including the use as further storage locations. As illustrated in FIG. 1, computer system 101 may also further comprises storage means 107.

In case the software 111 (e.g., ERP software) carries out method(s) consistent with the invention, program modules 106, 110 may be processed by CPU 105. The processing may comprise module 106 querying table 109 for invoices that are due within U days and the balance of which is equal or greater than X. Module 106 may enter a state S2U into the state field of the respective invoice(s), invoice no. 003 in the example shown. Module 106 further queries table 109 for invoices, which meet further predefinable conditions and enters corresponding states into the state fields. Examples are: state S1 for “balance>=X” and state S3 for “X>balance>=Y”. Module 106 further assigns a further state, a priority type state “MP” (medium priority) to invoice 003. This may be performed by presenting a corresponding input request to a user, who then decides what priority the corresponding invoice shall have. The user may then enter the state (e.g., by clicking a corresponding box) and module 106 writes the state into the state field. Default values may be set for the states when creating the data record for an invoice. Priority states may also be set automatically, e.g., by automatically assigning a low priority state to all invoices, the balance of which is smaller than a preselectable value, or a high priority state to all invoices, the balance of which is greater or equal than a preselectable first value, or to which special contractual conditions apply. Module 106 may also query table 109 for such invoices, which are due on a preselectable date or within a preselectable date and to which a first state is assigned, and assign a second state to such selected invoices. For example, module 106 queries table 109 for invoices, which are due within V days, checks whether the State1 field for that invoices is other than default and assigns a second state to such invoices as pointed out above. Alternatively, this may also be implemented by checking, whether a state “V” (or “U”) is contained in the State1 field, and by assigning a second state to such invoices as pointed out above. For example: All invoices, which are due in V=6 months, shall “now” (at the time of selection) have the state “low priority”.

Subsequently or parallel to that procedure, module 110 queries table 109 for medium priority invoices having the state S2U, extracts preselectable data from the respective invoices and presents the extracted date to a user in the form of a to-do-list 115 on a display 104. A user can evaluate the list and can decide whether, and in case yes, what actions should be performed next. In order to support this, the to-do-list may comprise check boxes or buttons by means of which further actions can be initiated. For example, a button assigned to each invoice may cause, if it is applied, that a list of possible actions is presented to the user for selection. For instance, that an e-mail with a predefinable content is sent to the customer of the respective invoice. Presenting the to-do-list can also be performed on other network computers 113.

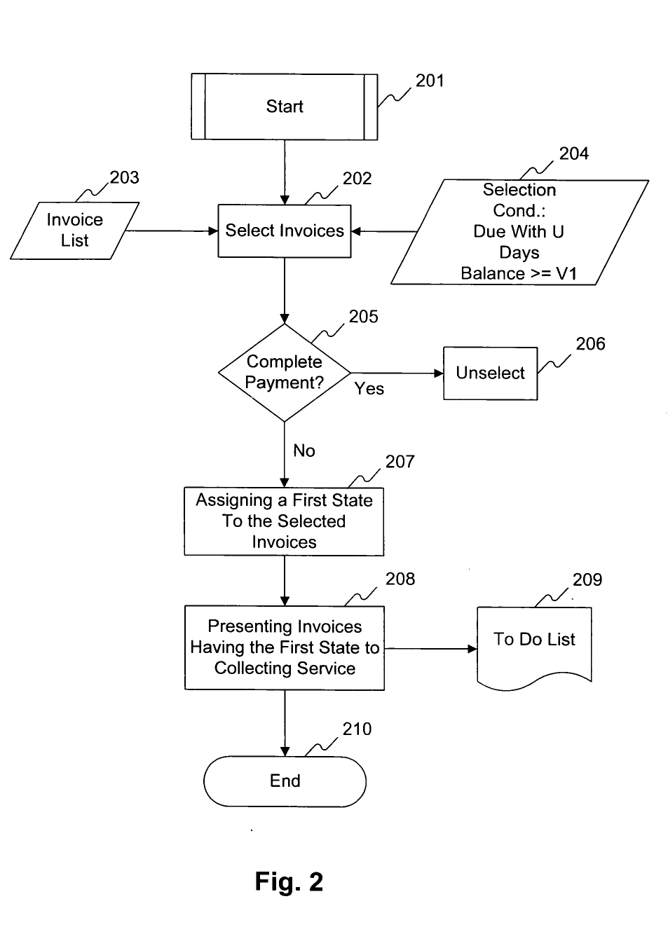

FIG. 2 shows a flow diagram of an exemplary method, consistent with an embodiment of FIG. 2. FIG. 2 may be implemented to perform, for example, a process consistent with process/module 106 of FIG. 1. As shown in FIG. 2, after a start step 201, a list of invoices (see 203) is queried at step 202 according to a set of selection conditions (see 204). In the example, the set consists of only one condition: the balance of an invoice has to be greater than a value V1. For the thus selected invoices, it is checked in an optional step 205 whether a full payment has been received. In the case yes, the respective invoice is withdrawn from the list of selected invoices (i.e., “unselected”) in step 206. In a further step (not shown), the state of the respective invoice may be changed to “paid.”

In a step 207, a first state is assigned to invoices for which none or only a partial payment has been received. Invoices having a preselectable first state are then presented as a to-do-list (see 209) in a step 208 to a collecting service, e.g., a user in a collecting department of the company. The exemplary process may then end at step 210.

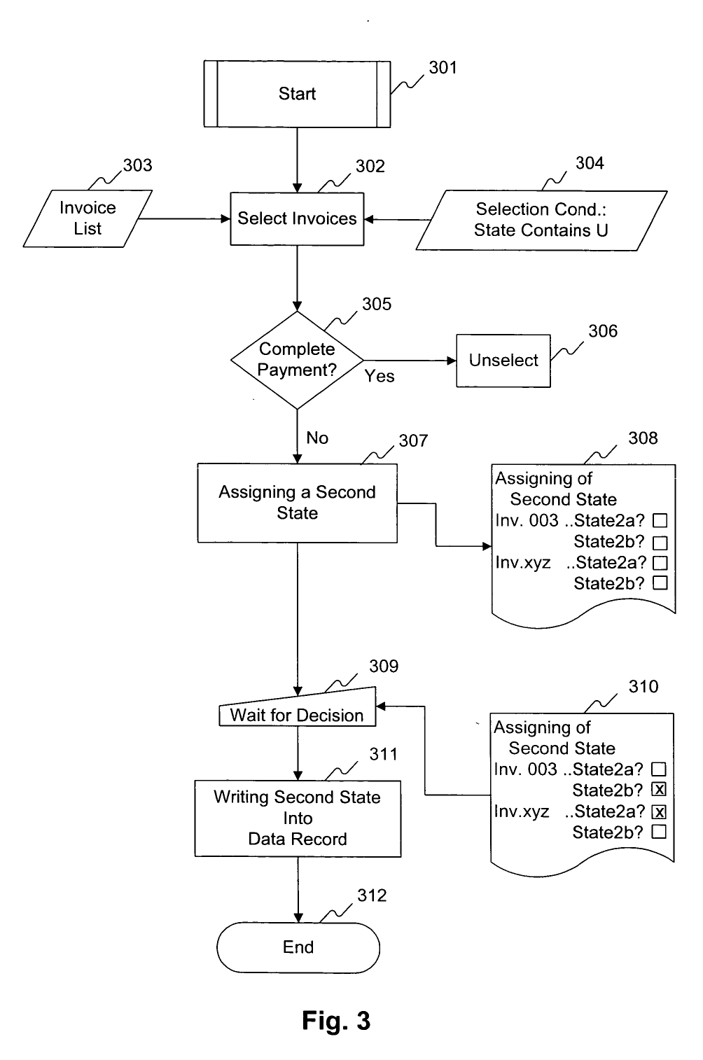

FIG. 3 shows a flow diagram of an another exemplary method, consistent with an embodiment of the invention. As will be appreciated, the process of FIG. 3 provides another example for process for execution with the computer system of FIG. 1. As illustrated in FIG. 3, after a start step 301, a list of invoices (see 303) is queried in a step 302 according to a set of selection conditions (see 304). In the example, the set consists of only one condition: a state of an invoice has to contain “U,” which means that the invoice is due within U days. For the thus selected invoices, it is checked in an optional step 305 whether a full payment has been received. In the case of yes, the respective invoice is withdrawn from the list of selected invoices in step 306. In a further step (not shown), the state of the respective invoice may be changed to “paid.”

In steps 307, 309, and 311, a second state is assigned to invoices, for which none or only a partial payment has been received. For this purpose, a list (see 308) showing the selected invoices may be presented to the user. The list 308 may comprises information on the invoice and for each invoice, the list may also contain means for selecting a state to the invoice. In the example, the user can chose whether the invoices 003 and xyz shall have the state “state2a” or “state2b.” The user clicks the corresponding boxes, while the process is waiting in step 309 for the decision. When the user has finished the selection, the process writes the selected states into the state fields of the data records in step 311. The exemplary process may then terminate in step 312.

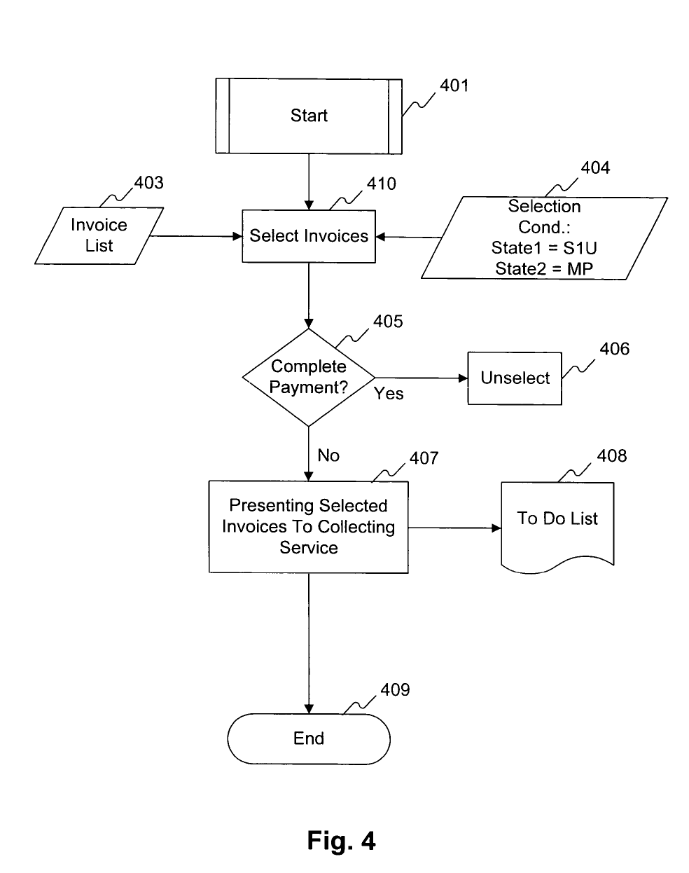

FIG. 4 shows a flow diagram of yet another exemplary method, consistent with an embodiment of the present invention. As with FIGS. 2 and 3, FIG. 4 provides an example of a process that may be implemented with the computer system of FIG. 1. Referring to FIG. 4, after a start step 401, a list of invoices (see 403) is queried in a step 402 according to a set of selection conditions (see 404). In the example, the set consists of two conditions: the first state of an invoice is “S1U” and the second state is “MP.” For the thus selected invoices in step 410, it is checked in an optional step 405 whether a full payment has been received. In the case of yes, the respective invoice is withdrawn from the list of selected invoices in step 406. In a further step (not shown), the state of the respective invoice may be changed to “paid.”

In a step 407, invoices having the preselectable first and second state are then presented as a to-do-list (see 408) to a collecting service, e.g., a user in a collecting department of the company. The exemplary process may then end in step 409.

As a result of the process of FIG. 4, a user in the collecting department may initiate actions with regard to each specific invoice, e.g., call the customer by phone or send an email. In case the reaction of the customer on the action satisfies the expectations of the user, this can be entered into the data record by a corresponding state. If there is no response or a dissatisfactory reaction is received from the customer within a preselectable time, a further to-do-list may be presented to the collecting division. The further to-do-list may comprise a list of possible actions for selection, depending on the type of reaction the customer provided. For example: an invoice may be passed to a credit control area in case financial challenges like bankruptcy of the customer occur; an invoice may be re-routed to a front office, if commercial challenges like dissatisfaction of the customer with delivered goods occurs; or an invoice may be re-routed to a back office if invoicing challenges like wrong address or delivery challenges like incomplete delivery occur.

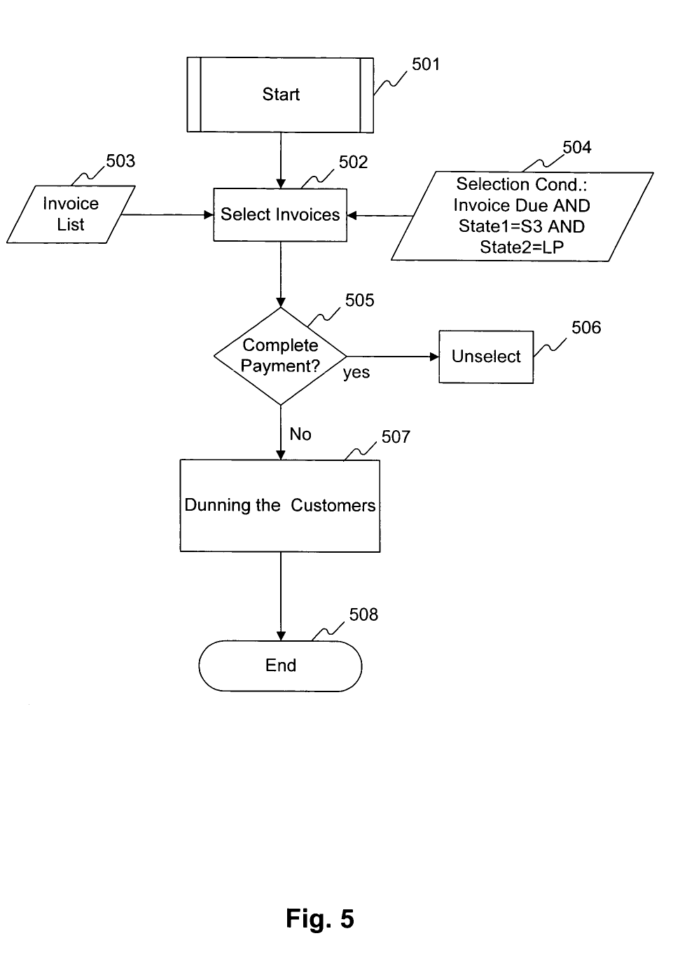

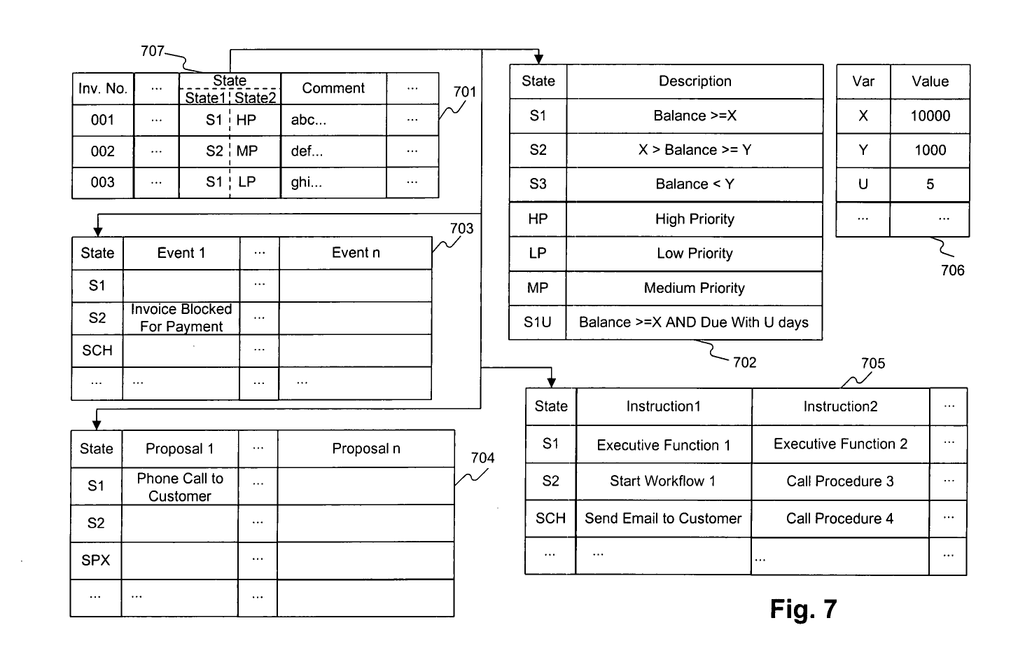

FIG. 5 shows a flow diagram of a still further exemplary method, consistent with an embodiment of the invention. The method of FIG. 5 may be implemented with the computer system of FIG. 1. As shown in FIG. 5, after a start step 501, a list of invoices (see 503) is queried in a step 502 according to a set of selection conditions (see 504). In the example, the set consists of three conditions: the first state (State1) is S3 (i.e., balance of the invoice has to be smaller than a value Y (see FIG. 7)), the invoice has to be due, and the second state (State2) is a low priority (LP). For the thus selected invoices, it is checked in an optional step 505 whether a full payment has been received. In the case of yes, the respective invoice is withdrawn from the list of selected invoices at step 506. In a further step (not shown), the state of the respective invoice may be changed to “paid.”

The customers accompanying the invoices, for which none or only a partial payment has been received, are then automatically dunned in step 507. This may be performed by, for example, automatically sending dunning letters or dunning e-mails to the customers. The exemplary process of FIG. 5 then may end at step 508.

As an alternative to dunning customers, unsettled invoices may be presented as a to-do-list (like 209 in FIG. 2) to a collecting service, e.g., a user in a collecting department of the company in order to confirm the dunning by the collecting service before the dunning letter or e-mail is sent out. If no reaction is received from the dunned customer within a preselectable time, the respective invoices may be presented to a collecting agency. In case a reaction is received from the customer, a further to-do-list may be presented to the collecting division. The further to-do-list may comprise a list of possible actions for selection, depending on the type of reaction the customer provided. For example: an invoice may be passed to a credit control area in case financial challenges like bankruptcy of the customer occur; an invoice may be re-routed to a front office if commercial challenges like dissatisfaction of the customer with delivered goods occurs; or an invoice may be re-routed to a back office if invoicing challenges like wrong address or delivery challenges like incomplete delivery occur.

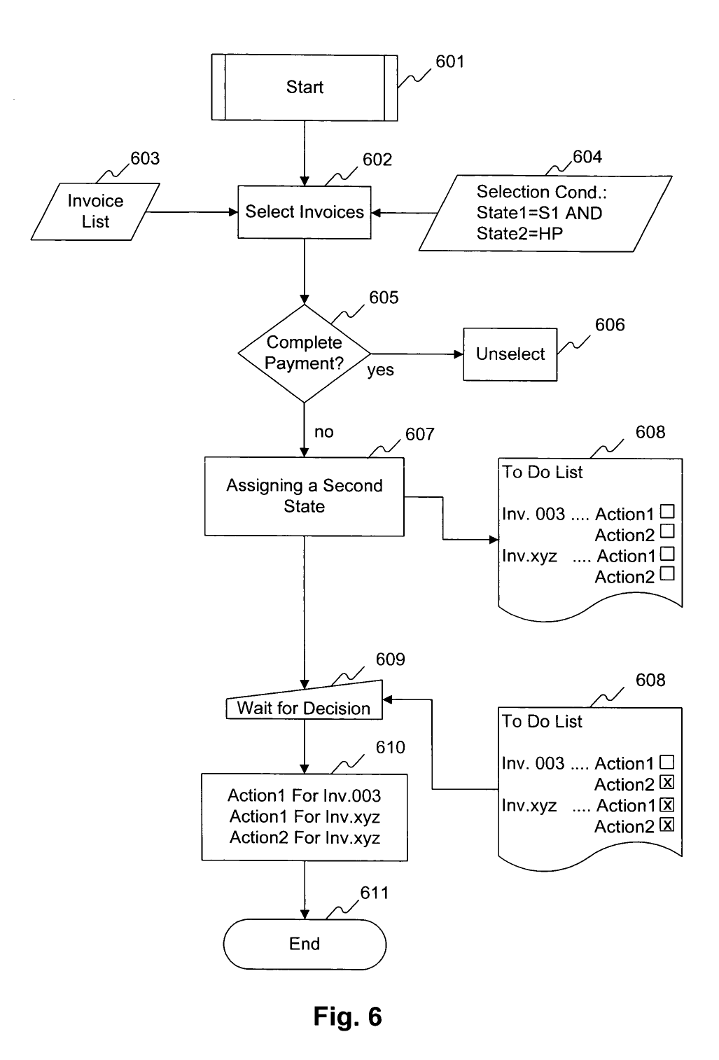

FIG. 6 illustrates a flow diagram of a further exemplary method, consistent with an embodiment of the invention. The exemplary embodiment of FIG. 6 may be implemented with the computer system of FIG. 1. As shown in FIG. 6, after initiating the process in a start step 601, a list of invoices (see 603) is queried in a step 602 according to a set of selection conditions (see 604). In the example, the set may include two conditions: a first state field has to contain S1 (e.g., balance of an invoice has to be greater than a value V1; see FIG. 7) and a second state has to be a high priority (HP). For the thus selected invoices, it is checked in an optional step 605 whether a full payment has been received. In the case of yes, the respective invoice is withdrawn from the list of selected invoices in step 606. In a further step (not shown), the state of the respective invoice may be changed to “paid.” The invoices, for which none or only a partial payment has been received, are then presented as a to-do-list (see 608) to a collecting service, e.g., a user in a collecting department of the company, in step 607. The user then can decide what action has to taken next, e.g., by selecting one of a list of proposed actions, which is incorporated into the to-do-list 608. The process may wait for that decision in step 609. The selected action is then automatically carried out in step 610. An example for such an action is presenting the invoice to an in-house clearing division for deciding whether to present it to an external collecting agency or not. The exemplary process of FIG. 6 may then end at step 611.

The optional steps for checking whether payments have been received can also be performed before starting the respective processes, e.g., when creating the invoice lists 203 to 603.

FIG. 7 shows an example of a data structure of an invoice, consistent with an embodiment of the present invention. The data structure may be implemented as a table 701 having a plurality of columns. By way of example, a column 707 for the first and second state of the invoice may be contained. The fields of the column 707 may contain strings of a length of at least four characters. The first two characters may be defined to represent the first state, and the second two characters may represent the second state. Further groups of characters may be used to define further states, depending on the length of the field. Depending on the number of states, one character per state may be sufficient. Alternatively n columns for n states can be used as well. Combinations of both alternatives are also possible.

In the example of FIG. 7, the individual data records of the invoices may be implemented as individual lines of table 701. The state column 707 of table 701 may comprise one state field for each invoice. In a table 702, a description is assigned to a state. By means of table 703, one or more events 1 to n are assigned to a state. By means of table 704, one or more proposals 1 to n are assigned to a state. By means of table 505, one or more events 1 to n are assigned to a state. Tables 702 to 705 are linked to table 701 by the state column. In a table 706, values of variables may be stored. The conditions, which are applied when querying the list of invoices, may be stored in a table as well.

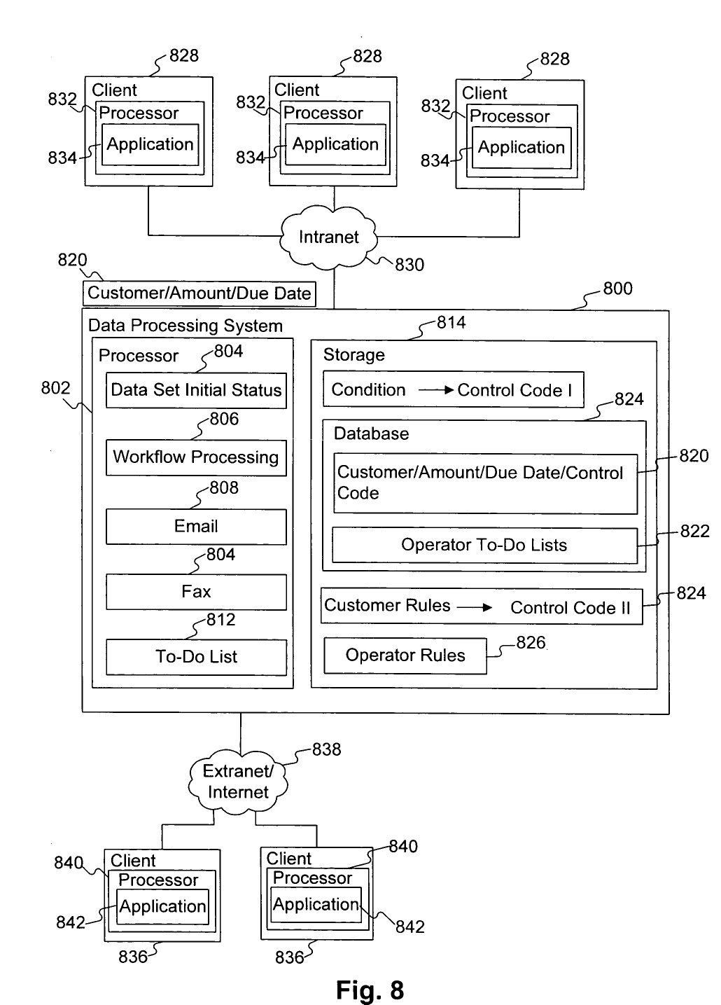

FIG. 8 is a block diagram of an exemplary data processing system, consistent with an embodiment of the invention. FIG. 8 shows a data processing system 800 that has at least one processor 802. The processor 802 serves for execution of a program component 804. The program component 804 has instructions that are executable by the processor 802 and which serve to determine an initial status of a dataset 820 received by the data processing system 800.

Further, the processor 802 serves for execution of program components 806, 808, 810 and 812. Program component 806 is a workflow processing program component that serves for processing of datasets in accordance with a workflow. Program component 808 may be an email program component that serves to automatically generate and send email messages. Program component 810 may be a fax program component that serves for automatic generation and sending of fax messages. Program component 812 serves for generating entries for operator specific to-do-lists.

The data processing system 800 has a storage 814. The storage 814 has a storage area 816 for storage of a predefined condition to which a control code I is assigned. Further, the storage 814 serves for storage of a database 818. The database 818 serves for storage of datasets 820 and operator specific to-do-lists 822.

The storage 814 has storage area 824 for storage of rules. If a dataset 820 meets a given rule, a respective control code II is assigned to that dataset. For example, the rules of storage area 824 are customer specific rules that encode customer specific steps of a workflow.

Further, the storage 814 has a storage area 826 for the storing of operator rules. By means of the operator rules stored in the storage area 826 a given dataset 820 is assigned to an operator or a group of operators and a respective entry to the operator specific to-do-list 822 is added.

A number of client computers 828 may be coupled to the data processing system 800 via a computer network, such as an intranet 830. Each client computer 828 has at least one processor 832 for execution of at least one application program 834. For example, the application programs 834 serve for entering of datasets 820.

After a dataset 820 has been entered by an operator into his or her client computer 828, the dataset 820 is transmitted via the intranet 830 to the data processing system 800 for further processing and entry into the database 818. Likewise, at least some of the operators using the client computers 828 may have the role of operators for processing datasets that have previously been entered into the database 818. Those operators can access their operator specific to-do-lists 822 for processing of the pre-processed datasets 820 stored in the database 818 in accordance with the respective to-do-lists 822.

A number of client computers 836 is coupled to the data processing system 800 via a computer network such as an extranet or the Internet 838. Each client computer 836 has at least one processor 814 for execution of at least one application program 842.

For example, application programs 842 are communication programs like Microsoft Outlook, Tobit InfoCentre or similar communication programs for receiving email and/or fax messages.

In operation, a dataset 820 is entered into one of the client computers 828 by means of the respective application program 834. The dataset 820 can include various data. In one application the dataset 820 includes an indication of the customer to which the dataset 820 refers, a payment amount to be paid by that customer, and a due date on which the payment of the payment amount by the customer becomes due. The dataset is transmitted from the client computer 828 via the intranet 830 to the data processing system 800. Receipt of the dataset 820 by the data processing system 800 invokes program component 804.

The program component 804 reads the condition from the storage area 816 and applies the condition to the dataset 820. If the dataset 820 meets the condition, the program component 804 assigns the control code I to the dataset 820.

Next, the program component 804 reads the customer rules from the storage area 824. If the dataset 820 meets one of the customer rules, the program component 804 assigns the respective control code II to the dataset 820.

For example, the predefined condition stored in the storage area 816 is a threshold value. If the dataset 820, which is examined by the program component 804, specifies a payment amount that is above the threshold level and if the actual date given by the data processing system's 800 system clock is before the due date, the condition is met by the dataset 820 and the control code I is assigned to the dataset 820. Assigning the control code I to the dataset 820 makes this dataset special as it is processed in accordance with a special workflow that is different from the usual processing of datasets 800 that do not meet the condition.

For example, the customer rules indicate a preferred communication means of a given customer. A customer A may prefer to receive email messages, a customer B prefers fax messages, and customer C prefers to receive a telephone call from a human operator. In this instance, there are three different control codes 11 that indicate whether email, fax or telephone communication is preferred by a given customer. Further, in this instance, the program component 804 uses the customer name given in the dataset 820 in order to determine the applicable control code II. Next, the program component 804 appends the control codes I and II to the dataset 820 for later reference and stores the dataset 820 in the database 818.

The program component 806 may be invoked automatically, such as hourly, daily or weekly, depending on the customization of the data processing system 800. The program component 806 may be invoked automatically when the system time of the data processing system 800 equals a predefined time value. The time value may be a time when the data processing load of the data processing system is usually low, such as during the night.

The program component 806 queries the database 818 in order to retrieve datasets 820 that have an assigned control code I after it has been invoked automatically. The list of datasets 820 that is returned by the query is processed by the program component 806 in accordance with the control codes 11 that are assigned to the respective datasets 820 of the list.

For those datasets 820 that have an assigned control code II indicating email communication as a preferred communication medium, the program component 806 may invoke program component 808 in order to automatically generate and send email messages to the respective customers. Likewise, program component 806 may invoke program component 810 in order to automatically generate and send fax messages to those customers who prefer to receive fax messages rather than email messages.

For those datasets 820 having an assigned control code II which indicates that receiving a telephone call from a human operator is the preferred way of communication, the program component 806 invokes the program component 812 in order to add respective entries to the operator specific to-do-lists 822. In order to determine which operator or group of operators is responsible for making the telephone call, the program component 806 uses the operator rules stored in the storage area 826 as these operator rules specify how the assignment of the new tasks to the operators or groups of operators is to be performed.

For example, all datasets 820 that have customer names beginning with A, B or C are processed by a first group of operators, datasets 820 which have customers' names beginning with D, E, F are processed by a second group of operators and so on. The respective new entries into the operator specific to-do-lists 822 are stored in the database 818.

After processing of a dataset 820 by the program component 806, the control code that is assigned to that dataset 820 is updated in order to reflect that the processing step of sending the message to the customer or adding a to-do-entry onto an operator specific to-do-list 822 has been performed. When the program component 806 is invoked at a subsequent point of time, it may also query the database 818 for datasets 820 having the assigned updated control codes in order to take further action depending on the required workflow.

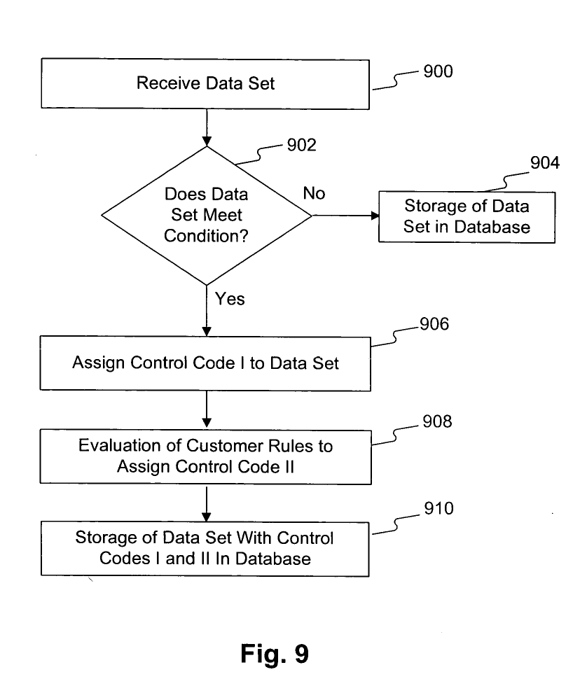

FIG. 9 is a flow diagram illustrating an exemplary assignment of control codes to the dataset, consistent with an embodiment of the invention. In step 900, the data processing system receives the dataset. In step 902, the dataset is checked to determine whether it meets a predefined condition. If the dataset does not meet the condition, the dataset is stored in the database in step 904. If the dataset does meet the condition, the control goes to step 906 where a control code I is assigned to the dataset in order to make the dataset special. In step 908 rules, such as customer specific rules, are evaluated in order to assign a control code II to the dataset. The control code II indicates a customer specific way of further processing of the dataset. In step 910, the dataset with the assigned control codes I and II is stored in the database.

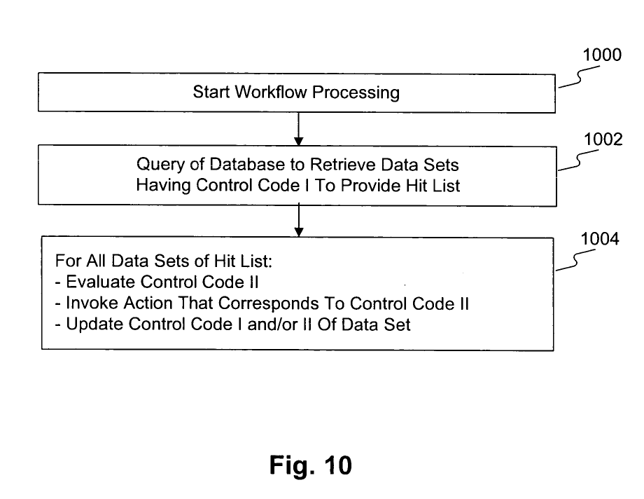

FIG. 10 shows a flowchart illustrating an exemplary processing of the special datasets that are stored in the database, consistent with an embodiment of the present invention. In step 1000, the workflow processing program component is invoked. In step 1002, the workflow processing program component queries the database in order to retrieve datasets having an assigned control code I. This may provide a hit list of datasets for the further processing by the workflow processing program component.

In step 1004, the workflow processing program component processes all datasets of the hit lists. For a given dataset of the hit list, the workflow processing program component may evaluate the control code II that is assigned to that dataset. The workflow processing program component may initiate an action that corresponds to the control code II, such as sending an email message, a fax message or adding an entry onto a to-do-list of an operator for calling the customer. Further, the control codes I and/or II of the dataset may be updated in order to reflect the action that has been initiated by the workflow processing program component.

The data processing system may be advantageously used for processing of invoices. Embodiments of the present invention may facilitate to substantially reduce the data processing load of the data processing system 800 because only a sub-set of all invoices is processed in a special way by the workflow processing program component whereas the remainder of the invoices is processed in a standard way. For example, those invoices which do not meet the predefined condition are only processed after the due date has passed and no payment has been received. In this instance, automatic payment reminders are generated and sent in a non-customer specific way to the respective customers to remind them on the payment.

It is to be noted that the control codes I and 11 that are assigned to the special invoices are expressive of a present state, e.g. “state 1” and “state 2” of the invoice as explained with respect to the embodiments of, for example, FIGS. 1 to 7.

Modifications and adaptations of the present invention will be apparent to those skilled in the art from consideration of the specification and practice of the embodiments of the invention disclosed herein. The foregoing description of implementations of the invention has been presented for purposes of illustration and description. It is not exhaustive and does not limit the invention to the precise forms or features disclosed. Modifications and variations are possible in light of the above teachings or may be acquired from practicing the disclosed embodiments of the invention. For example, several of the described implementations include software, but systems and methods consistent with the invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

Other embodiments of the invention will be apparent to those skilled in the art from consideration of the specification and practice of the embodiments and features of the invention disclosed herein. It is intended, therefore, that the specification and examples be considered as exemplary only, with a true scope and spirit of the invention being indicated by the following claims.

1. A method for computerized processing of invoices, the invoices being presented by a company to a plurality of customers, the method comprising:
selecting, from a plurality of invoices, invoices that are due within a preselectable time or on a preselectable date and having a balance that is larger than a preselectable first value; and
assigning a first state to the selected invoices.

2. The method of claim 1, further comprising:
selecting from the plurality of invoices one or more invoices and assigning a second state to the selected invoices.

3. A method for computerized processing of invoices, the method comprising:
selecting, from a plurality of invoices, one or more invoices that are due within a preselectable time or on a preselectable date and to which a first state is assigned; and
assigning a second state to the selected invoices.

4. The method of claim 3, wherein the one or more invoices are invoices of special importance.

5. The method of claim 3, further comprising:
selecting, from the plurality of invoices, invoices having a balance that is larger than a preselectable first value.

6. The method of claim 3, wherein the first and second states are states of high priority.

7. The method of claim 3, further comprising:
selecting, from the plurality of invoices, invoices having a balance that is smaller than a preselectable second value and larger than a preselectable third value; and
assigning a third state to the selected invoices, wherein the second value is smaller than or equal to the first value and the third value is smaller than the second value.

8. The method of claim 7, wherein the second state is a state of medium priority.

9. The method of claim 7, further comprising:
selecting, from the plurality of invoices, invoices having a balance that is smaller than the third value and assigning a fourth state to the selected invoices.

10. The method of claim 9, wherein the fourth state is a state of low priority.

11. The method of claim 9, wherein the preselectable first value is such that a preselectable percentage of the outstanding active debts or turnover of the company is controlled.

12. The method of claim 9, further comprising:
presenting the invoices of at least one of the first state and second state and third state and fourth state to a cash collector.

13. The method of claim 12, further comprising:
presenting the invoices having a first or second state at a presetable first period of time before the due date to the cash collector.

14. The method of claim 12, further comprising:
presenting the invoices having a third state at a presetable second period of time before the due date to the cash collector.

15. The method of claim 12, further comprising:
presenting the invoices having the fourth state at a presetable third period of time before the due date to the cash collector.

16. The method of one of claim 12, further comprising:
controlling whether payments according to the invoices of the first and/or second state have been made before or on or after the due date; and
presenting, in the case of a non payment, such invoices to a collecting service.

17. The method claim 13, wherein the second period of time is smaller than the first period of time and the third period of time is smaller than the second period of time.

18. The method of claim 14, wherein the second period of time is smaller than the first period of time and the third period of time is smaller than the second period of time.

19. The method of claim 15, the second period of time is smaller than the first period of time and the third period of time is smaller than the second period of time.

20. The method of claim 9, further comprising: dunning the customers of the accompanying due invoices.

21. The method of claim 16, wherein the collection service is a collection division of the company or an external collecting agency.

22. The method of claim 16, further comprising:
checking whether a non-payment is reasoned and, if not, presenting such invoice to an external collecting agency.

23. The method of claim 16, further comprising:
presenting the selected invoices to the collecting service by means of a to-do-list.

24. The method of claim 3, further comprising:
receiving a request for a state change of an invoice from a customer; and
changing the state of the invoice according to the request.

25. The method of claim 24, further comprising:
presenting the request to an internal clearing division before changing the state.

26. The method of claim 3, wherein the method is for use in software for supporting business processes, the software comprising enterprise resource planning software.

27. A computer system for computerized processing of invoices, the computer system comprising:
a memory including program instructions;
input means for receiving and entering data;
output means for sending and presenting data;
storage means for storing data; and
a processor responsive to the program instructions, the instructions being adapted to cause the processor to:
select, from a plurality of invoices, invoices that are due within a preselectable time or on a preselectable date and having a balance that is larger than a preselectable first value, and
assign a first state to the selected invoices.

28. The computer system of claim 27, further comprising:
selecting, from the plurality of invoices, one or more invoices; and
assigning a second state to the selected invoices.

29. A computer system for computerized processing of invoices, the computer system comprising:
a memory including program instructions;
input means for receiving and entering data;
output means for sending and presenting data;
storage means for storing data; and
a processor responsive to the program instructions, the instructions being adapted to cause the processor to:
select, from a plurality of invoices, one or more invoices that are due within a preselectable time or on a preselectable date and to which a first state is assigned; and
assigning a second state to the selected invoices.

30. The computer system of claim 29, wherein the one or more invoices are invoices of special importance.

31. The computer system of claim 29, further comprising:
selecting, from the plurality of invoices, invoices having a balance that is larger than a preselectable first value.

32. The computer system of claim 29, wherein the first and second states are states of high priority.

33. The computer system of claim 29, further comprising:
selecting, from the plurality of invoices, invoices having a balance that is smaller than a preselectable second value and larger than a preselectable third value; and
assigning a third state to the selected invoices, the second value being smaller or equal than the first value and the third value being smaller than the second value.

34. The computer system of claim 33, wherein the second state is a state of medium priority.

35. The computer system of claim 33, further comprising:
selecting, from the plurality of invoices, invoices having a balance that is smaller than the third value and assigning a fourth state to such selected invoices.

36. The computer system of claim 35, wherein the fourth state is a state of low priority.

37. The computer system of claim 35, wherein the preselectable first value is such that a preselectable percentage of the outstanding active debts or turnover of the company is controlled.

38. The computer system of claim 35, further comprising:
presenting the invoices of at least one of the first state and second state and third state and fourth state to a cash collector.

39. The computer system of claim 35, further comprising:
presenting the invoices having a first or second state at a presetable first period of time before the due date to the cash collector.

40. The computer system of claim 35, further comprising:
presenting the invoices having a third state at a presetable second period of time before the due date to the cash collector.

41. The computer system of claim 35, further comprising:
presenting the invoices having a fourth state at a presetable third period of time before the due date to the cash collector.

42. The computer system of claim 35, further comprising:
controlling whether payments according to the invoices of the first and/or second state have been made before or on or after the due date; and
presenting, in the case of a non payment, such invoices to a collecting service.

43. The computer system of claim 35, wherein:
the second period of time is smaller than the first period of time and the third period of time is smaller than the second period of time.

44. The computer system of claim 35, further comprising:
dunning the customers of the accompanying due invoices.

45. The computer system of claim 38, wherein:
the cash collector is associated with a collection division of the company or an external collecting agency.

46. The computer system of claim 27, further comprising:
checking whether a non-payment of an invoice is reasoned; and
presenting, in the case the non-payment is not reasoned, such invoice to an external collecting agency.

47. The computer system of claim 27, further comprising:
presenting the selected invoices to a collecting service by means of a to-do-list.

48. The computer system of claim 27, further comprising:
receiving a request for a state change of an invoice from a customer; and
changing the state of the invoice according to the request.

49. The computer system of claim 48, further comprising:
presenting the request to an internal clearing division before changing the state.

50. The computer system of claim 27, wherein the computer system is for use in software for supporting business processes, the software comprising enterprise resource planning software.

51. The computer system of claim 27, wherein the one or more invoices are invoices of special importance.

52. The computer system of claim 29, further comprising:
selecting, from the plurality of invoices, invoices having a balance that is larger than a preselectable first value.

53. The computer system of claim 29, wherein the first and second states are states of high priority.

54. The computer system of claim 29, further comprising:
selecting, from the plurality of invoices, invoices having a balance that is smaller than a preselectable second value, and larger than a preselectable third value; and
assigning a third state to such selected invoices, the second value being smaller or equal than the first value and the third value being smaller than the second value.

55. The computer system of claim 29, wherein the second state is a state of medium priority.

56. The computer system of claim 29, further comprising:
selecting, from the plurality of invoices, invoices having a balance that is smaller than the third value and assigning a fourth state to such selected invoices.

57. The computer system of claim 56, wherein the fourth state is a state of low priority.

58. The computer system of claim 29, wherein the preselectable first value is such that a preselectable percentage of the outstanding active debts or turnover of the company is controlled.

59. The computer system of claim 56, further comprising:
presenting the invoices of at least one of the first state and second state and third state and fourth state to a cash collector.

60. The computer system of claim 59, further comprising:
presenting the invoices having a first or second state at a presetable first period of time before the due date to the cash collector.

61. The computer system of claim 59, further comprising:
presenting the invoices having a third state at a presetable second period of time before the due date to the cash collector.

62. The computer system of claim 59, further comprising:
presenting the invoices having the fourth state at a presetable third period of time before the due date to the cash collector.

63. The computer system of claim 59, further comprising:
controlling whether payments according to the invoices of the first and/or second state have been made before or on or after the due date; and
presenting, in the case of a non payment, such invoices to a collecting service.

64. The computer system of claim 29, wherein the second period of time is smaller than the first period of time and the third period of time is smaller than the second period of time.

65. The computer system of claim 29, further comprising:
dunning the customers of the accompanying due invoices.

66. The computer system of claim 63, wherein the collecting service is a collection division of the company or an external collecting agency.

67. The computer system of claim 29, further comprising:
checking whether a non-payment of an invoice is reasoned; and
presenting, in the case that non-payment is not reasoned, such invoice to an external collecting agency.

68. The computer system of claim 29, further comprising:
presenting the selected invoices to the collecting service by means of a to-do-list.

69. The computer system of claim 29, further comprising:
receiving a request for a state change of an invoice from a customer; and
changing the state of the invoice according to the request.

70. The computer system of claim 69, further comprising:
presenting the request to an internal clearing division before changing the state.

71. The computer system of claim 29, wherein the computer system is for use with software for supporting business processes, the software comprising enterprise resource planning software.

72. A computer readable medium comprising instructions for computerized processing of invoices, the invoices being presented by a company to two or more customers, the computer readable medium comprising instructions for performing a method according to any one of claims 1-26.

73. A computer data signal embodied in a carrier wave comprising code for computerized processing of invoices, the invoices being presented by a company to two or more customers, the code comprising instructions for:
selecting, from a plurality of invoices, invoices that are due within a preselectable time or on a preselectable date and having a balance that is larger than a preselectable first value; and
assigning a first state to the selected invoices.

74. A data processing system comprising:
means for receiving a dataset;
means for assigning a first control code to the dataset if the dataset fulfills a predefined condition;
database means for storing the dataset and its first control code, if any means for retrieving datasets having assigned first control codes from the database; and
means for processing the retrieved datasets.

75. The data processing system of claim 74, further comprising: means for assigning a second control code to datasets that have an assigned first control code, the means for processing the retrieved datasets being adapted to process the retrieved datasets depending on the second control code.

76. The data processing system of claim 75, wherein the second control code is indicative of a type of an electronic message, the electronic message containing at least a portion of the respective dataset.

77. The data processing system of claim 76, wherein the second control code is indicative of an email or fax message.

78. The data processing system of claim 75, wherein the second control code is indicative for adding an item to a to-do-list for an operator's processing of the respective dataset.

79. A data processing method comprising:
receiving a dataset;
assigning a first control code to the dataset if the dataset fulfills a predefined condition;
storing the dataset and its assigned first control code in a database;
retrieving datasets having assigned first control codes from the database; and
processing the retrieved datasets.

80. The data processing method of claim 79, further comprising:
assigning a second control code to datasets that have an assigned first control code, and wherein the processing of the retrieved datasets is performed depending on the second control code.

81. The data processing method of claim 80, wherein the second control code indicates a type of an electronic message that is to be sent for a respective dataset or an item that is to be added to an operator's to-do-list for the respective dataset.

82. A computer program product comprising computer executable instructions for performing a data processing method, the method comprising the steps of:
receiving a dataset;
assigning a first control code to the dataset if the dataset fulfills a predefined condition;
storing the dataset and its assigned first control code in a database;
retrieving datasets having assigned first control codes from the database; and
processing the retrieved datasets.

83. The computer program product of claim 82, wherein the method further comprises:
assigning a second control code to datasets that have an assigned first control code, and wherein the processing of the retrieved datasets is performed depending on the second control code.

84. The computer program product of claim 82, wherein the second control code indicates a type of an electronic message that is to be sent for a respective dataset or an item that is to be added to an operator's to-do-list for the respective dataset.
